(19) United States
(12) Patent Application Publication
(10) Pub. No.: US 2012/0262285 A1
(43) Pub. Date: Oct. 18, 2012

(54) SMART TIRE-PRESSURE SENSING SYSTEM WITH PROTECTION MECHANISM AND PROTECTION METHOD THEREOF

(76) Inventors: Kuei-Chi HO, Taichung City (TW); Hsin-Chieh Chen, Taichung City (TW)

(21) Appl. No.: 13/086,953

(22) Filed: Apr. 14, 2011

(51) Int. Cl. B60C 23/02

(52) U.S. Cl. 340/442

(57) ABSTRACT

A smart tire-pressure sensing system with a protection mechanism and a protection method thereof are disclosed. The smart tire-pressure sensing system has at least one host and at least one tire-pressure sensor preprogrammed with multiple encoding systems. The tire-pressure sensor is configured to select one of the encoding systems during an installation period according to a code identification signal so as to establish a signal communication with the host, and to be locked from switching among the encoding systems after a signal locking period since the establish a signal communication is established, so as to prevent the installed tire-pressure sensor from being interfered with or getting reset unintentionally, thereby securing the signal communication between the tire-pressure sensor and the host.

### BACKGROUND OF THE INVENTION

1. Technical Field

The present invention relates to a smart tire-pressure sensing system, wherein a tire-pressure sensor supporting multiple encoding systems is capable of automatically matching a host, and wherein a protection mechanism and a protection method protect the selected encoding system against interference from other tire-pressure sensing systems.

2. Description of Related Art

Motor vehicles are undoubtedly the most important transportation to modern people, and therefore more and more attention has been paid to driving safety. For ensuring driving safety, tire pressure of vehicle tires is one major item to be well controlled. Improper tire pressure can lead to greater fuel consumption and inferior vehicle controllability, which threatens the safety of the drivers and the passengers.

A conventional tire-pressure sensing system includes a tire-pressure sensor configured to be installed in a tire of a vehicle for detecting air pressure and temperature inside the tire and transmitting the detected data through a transmitting device inside the tire-pressure sensor to a host installed on the vehicle, so as to facilitate a driver in the vehicle to see the data from a display communicating with the host.

However, different manufactures of tire-pressure sensing systems typically use different encoding systems to communicate tire-pressure sensors and hosts. Consequently, cars of different brands and times have their tire-pressure sensors and hosts provided with respective encoding systems that are not reprogrammable or revisable, meaning that tire-pressure sensors and hosts using different encoding systems cannot have common communication. As a result, the use of tire-pressure sensors is limited.

In a smart tire-pressure sensing system the inventor has earlier invented and filed a patent application therefor, there is at least one host and at least one tire-pressure sensor, wherein the tire-pressure sensor is to be installed in a tire to be monitored and has signal communication with the host, so as to transmit the measured tire pressure to the host. The tire-pressure sensor is preprogrammed with multiple encoding systems, and is capable of automatically selecting one of the encoding systems to establish the signal communication with the host according to a code identification signal, thereby being compatible to hosts using various encoding system.

In view of further needs for preventing an installed tire-pressure sensor from being interfered with by code identification signals of other hosts, and for preventing an installed tire-pressure sensor from losing its selected encoding system and inter the signal communication with the host due to reset during tire replacement, it is desired to have a smart tire-pressure sensing system with a protection mechanism and to have a protection method of the smart tire-pressure sensing system.

### SUMMARY OF THE INVENTION

To solve the foregoing problems, the present invention provides a smart tire-pressure sensing system with a protection mechanism and a protection method thereof. The present invention prevents an installed tire-pressure sensing system from being interfered with by other systems and from losing its established signal communication.

In the disclosed smart tire-pressure sensing system and its protection method, the smart tire-pressure sensing system comprises at least one host and at least one tire-pressure sensor, wherein the tire-pressure sensor is preprogrammed with multiple encoding systems, and, in an installation period, selecting one of the encoding systems corresponding to the host according to a code identification signal for establishing a signal communication with the host, and the protection method comprises the following steps:
a) installing the tire-pressure sensor onto a tire to be monitored;
b) inflating the tire to make a tire pressure thereof greater than a preset threshold, so as to enter the tire-pressure sensor into an installation process;
c) sending a code identification signal corresponding to the host to the tire-pressure sensor during the installation period;
d) making the tire-pressure sensor receive the code identification signal and select one of the encoding systems according to the code identification signal so as to establish the signal communication between the tire-pressure sensor and the host; and
e) if the tire-pressure sensor has never detected the tire pressure of the tire to be monitored as lower than the preset threshold over a signal locking period, entering the tire-pressure sensor into a locking process wherein the tire-pressure sensor is locked from switching among the encoding systems.

The present invention uses the protection mechanism to limit the tire-pressure sensor after entering the installation process to answer to the code identification signal and switch among the encoding systems within the installation period, so as to prevent the installed system from being interfered with by other hosts.

The present invention allows the tire-pressure sensor to be re-stared and recover its function of answering to the code identification signal and switching among the encoding systems during the signal locking period by easily discharging the tire with the tire-pressure sensor.

The present invention uses the locking process to lock the tire-pressure sensor after the signal locking period from entering the installing process again so as to prevent the tire-pressure sensor from losing the selected encoding system unintentionally, thereby ensuring the signal communication between the host and the tire-pressure sensor.

The present invention further includes a recovery process, wherein a restorer sending a recovery signal to the tire-pressure sensor that had selected the encoding system and has been locked from entering the installing process, so to restart and enter the tire-pressure sensor to the installing process, allowing the tire-pressure sensor to be installed onto another vehicle and work with another host.

### BRIEF DESCRIPTION OF THE DRAWINGS

The invention as well as a preferred mode of use, further objectives and advantages thereof will be best understood by reference to the following detailed description of illustrative embodiments when read in conjunction with the accompanying drawings, wherein:

FIG. 1 is a schematic drawing illustrating a smart tire-pressure sensing system of the present invention;

FIG. 2 is a schematic drawing depicting signal communication between a tire-pressure sensor and a host according to the present invention;

FIG. 3 is a flowchart of an automatic matching method of the present invention; and

FIG. 4 is a schematic drawing explaining a recovery process according to the present invention.

### DETAILED DESCRIPTION OF THE INVENTION

While a preferred embodiment provided hereinafter for illustrating the concept of the present invention as described above, it is to be understood that the components of the embodiment shown in the accompanying drawings are depicted for the sake of easy explanation and need not to be made to exact scale.

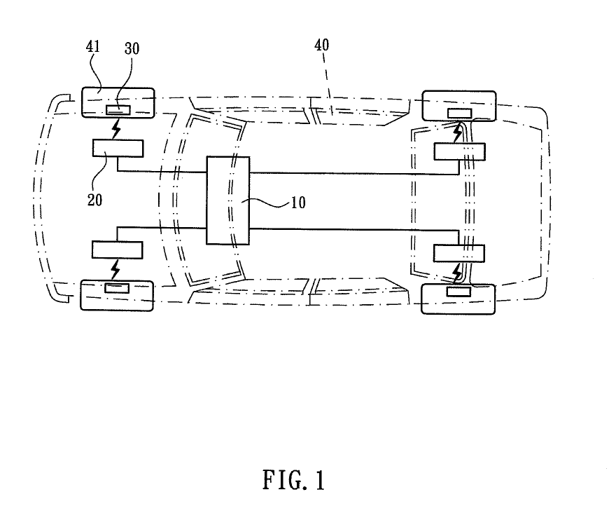

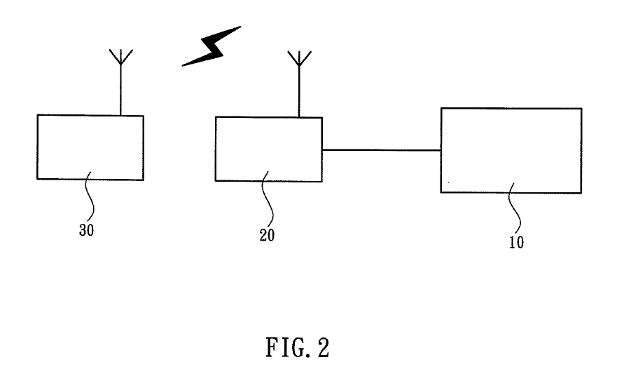

Referring to FIG. 1 and FIG. 2, a smart tire-pressure sensing system according to the present invention primarily comprises a host 10, at least one wireless transmitter 20, and at least one tire-pressure sensor 30.

The host 10 is installed on a vehicle 40, and each said wireless transmitter 20 is installed on the vehicle 40 at a proper position near a tire 41 whose tire pressure is to be monitored. The wireless transmitter 20 and the host 10 are connected in a wired manner.

Each said tire-pressure sensor 30 is installed in the tire 41 to be monitored. The tire-pressure sensor 30 and the host 10 are in wireless signal communication, so the measured tire pressure of the tire 41 can be transmitted to the host 10.

Therein, the tire-pressure sensor 30 is preloaded with a program compatible to multiple encoding systems. The program is configured to select one of the encoding systems to be in signal communication with the host 10 according to a code identification signal corresponding to the host 10, so that the measured tire pressure of the tire 41 can be transmitted to the host 10. After a signal locking period since the establishment of the signal communication, the tire-pressure sensor 30 is locked from switching among the encoding systems.

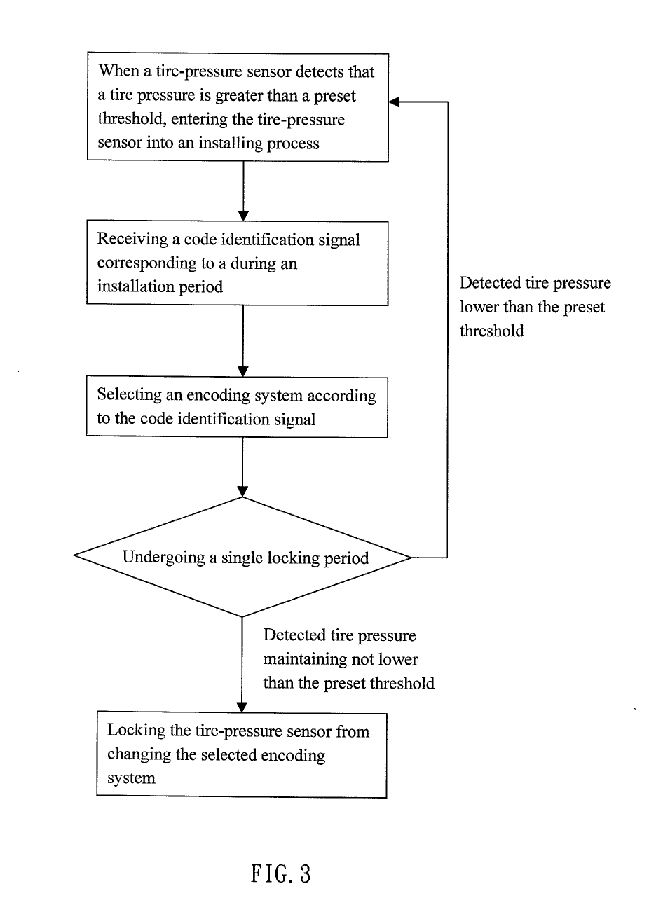

Referring to FIG. 3, a protection method for a smart tire-pressure sensing system of the present invention primarily comprises the following steps:
a) installing the tire-pressure sensor 30 onto a tire 41 to be monitored;
b) inflating the tire 41 to make a tire pressure thereof greater than a preset threshold, wherein the preset threshold may be zero pressure or a pressure value much lower than a proper pressure, so as to enter the tire-pressure sensor 30 into an installation process;
c) sending a code identification signal corresponding to the host 10 to the tire-pressure sensor 30 during an installation period;
d) making the tire-pressure sensor 30 receive the code identification signal and select one of the encoding systems according to the code identification signal so as to establish the signal communication between the tire-pressure sensor 30 and the host 10; and
e) if the tire-pressure sensor 30 has never detected the tire pressure of the tire to be monitored as lower than the preset threshold over a signal locking period, entering the tire-pressure sensor 30 into a locking process wherein the tire-pressure sensor is locked from switching among the encoding systems.

In the step c), the code identification signal is sent to the tire-pressure sensor 30 by the host 10 through a wireless transmitter 20, or by a code identifying tool, which is configured to directly send the code identification signal corresponding to the host 10, so as to facilitate automatically matching and thereby establishing the signal communication between the tire-pressure sensor 30 and the host 10.

Thereby, the tire 41 with the disclosed tire-pressure sensor 30 installed therein can be inflated, and the disclosed tire-pressure sensor 30 can automatically detect and receive the ode identification signal corresponding to the host 10, thereby selecting one of the encoding systems that allows the tire-pressure sensor 30 to send a detection signal matching the host 10, so as to allow the tire-pressure sensor 30 and the host 10 to automatically match and have signal communication therebetween.

During installation, it is usually easy to control the wireless environment around the devices, and thereby eliminate signal interference. However, without the disclosed protection mechanism, after installation, any code identification signals from adjacent other vehicles could cause the tire-pressure sensor 30 to reply wrongly and to lose its proper signal communication with the host 10. For preventing the installed system from being interfered with by other hosts, the disclosed protection mechanism only allows the tire-pressure sensor 30 after entering the installation process to answer to the code identification signal and switch among the encoding systems within the installation period (e.g. within one hour). In the event that the tire-pressure sensor 30 has never received other code identification signals over the installation period, the tire-pressure sensor 30 stops its function of answering to the code identification signal to switch among the encoding systems, so that undesired interference from the code identification signals of other vehicles can be eliminated.

In the event that tire-pressure sensor 30 during the signal locking period has to be reinstalled and reset due to installation defects or other reasons, the purpose can be easily achieved by discharging the tire 41 to the extent that its tire pressure becomes lower than the preset threshold so that the tire-pressure sensor 30 can recover its function of answering to the code identification signal to switch among the encoding systems, thereby facilitating a user's modifying or altering its setting.

In addition, the locking process may further include that, after the tire-pressure sensor 30 selects a certain encoding system, if the tire-pressure sensor 30 has never detected the tire pressure of the tire 41 to be monitored as lower than the preset threshold over the signal locking period (e.g. within 13 hours), it is locked from entering the installing process again, so as to prevent the tire-pressure sensor 30 from reentering the installing process due to tire leakage or other reasons that cause the tire pressure to be lower than the preset threshold, and thereby prevent the tire-pressure sensor 30 from disconnecting from the host 10 or unintentionally matching and connecting other hosts (such as a hosts in a nearby vehicle). Thereby, the tire-pressure sensor 30 is secured from being interfered by other hosts and transmitting the tire pressure measured by the tire-pressure sensor 30 to a wrong host, so as to ensure the connection between the host 10 and the tire-pressure sensor 30 installed in the same vehicle and correct reading of tire pressure presented at the host 10.

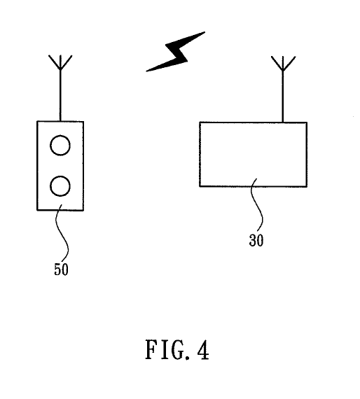

Moreover, as shown in FIG. 4, the present invention further comprises a recovery process. In the recovery process, the tire-pressure sensor 30 that had selected the encoding system and has been locked from entering the installing process receives a recovery signal from a restorer 50, so that the tire-pressure sensor 30 is re-started and entered into the installing process, thereby allowing the tire-pressure sensor 30 and the tire 41 that are to be installed onto to another car to have signal communication with another host 10, making the tire-pressure sensor 30 reusable.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A smart tire-pressure sensing system with a protection mechanism, the smart tire-pressure sensing system comprising at least one host and at least one tire-pressure sensor, and the tire-pressure sensor being installed in a tire to be monitored and being preprogrammed with a plurality of encoding systems, so that the tire-pressure sensor is capable of selecting one of the encoding systems during an installation period according to a code identification signal corresponding to the host and thereby establishing a signal communication with the host, and then transmitting a measured value of a tire pressure of the tire to the host, wherein after a signal locking period since the signal communication between the tire-pressure sensor and the host is established, the tire-pressure sensor is locked from switching among the encoding systems.

2. The smart tire-pressure sensing system of claim 1, further comprising a restorer for sending a recovery signal to the tire-pressure sensor.

3. A protection method for a smart tire-pressure sensing system, the smart tire-pressure sensing system comprising at least one host and at least one tire-pressure sensor, the tire-pressure sensor being preprogrammed with a plurality of encoding systems, and the protection method comprising steps of:
a) installing the tire-pressure sensor onto a tire to be monitored;
b) inflating the tire to make a tire pressure thereof greater than a preset threshold, so as to enter the tire-pressure sensor into an installation process;
c) sending a code identification signal corresponding to the host to the tire-pressure sensor during an installation period;
d) making the tire-pressure sensor receive the code identification signal and select one of the encoding systems according to the code identification signal so as to establish the signal communication between the tire-pressure sensor and the host; and
e) if the tire-pressure sensor has never detected the tire pressure of the tire to be monitored as lower than the preset threshold over a signal locking period, entering the tire-pressure sensor into a locking process wherein the tire-pressure sensor is locked from switching among the encoding systems.

4. The protection method of claim 3, wherein the step c) the code identification signal is sent to the tire-pressure sensor by the host.

5. The protection method of claim 4, wherein the host transmits the code identification signal to the tire-pressure sensor through a wireless transmitter.

6. The protection method of claim 3, wherein in the step c) the code identification signal is sent to the tire-pressure sensor by a code identifying tool.

7. The protection method of claim 3, wherein the tire-pressure sensor after entering the installation process and undergoing the installation period stop a function of answering to the code identification signal to switch among the encoding systems.

8. The protection method of claim 3, wherein the signal communication between the tire-pressure sensor and the host is wireless for transmitting the measured value of the tire pressure of the tire to the host.

9. The protection method of claim 3, wherein when the tire-pressure sensor detects that the measured value of the tire pressure of the tire is lower than the present threshold during the signal locking period, the tire-pressure sensor recovers a function of answering to the code identification signal to switch among the encoding systems.

10. The protection method of claim 3, further comprising a recovery process:
wherein a restorer sending a recovery signal to the tire-pressure sensor that has entered the locking process, so to restart and enter the tire-pressure sensor into the installing process.
